(19) United States
(12) Patent Application Publication
(10) Pub. No.: US 2026/0178424 A1
(43) Pub. Date: Jun. 25, 2026

(54) AUTONOMOUS API AGENT

(71) Applicant: Walmart Apollo, LLC, Bentonville, AR (US)

(72) Inventors: Praneeth Gubbala, Milpitas, CA (US); Raghavendra Subramanya, Frisco, TX (US)

(21) Appl. No.: 18/999,673

(22) Filed: Dec. 23, 2024

(51) Int. Cl. G06F 9/54

(52) U.S. Cl. CPC G06F 9/541

(57) ABSTRACT

Examples provide an autonomous application programming interface (API) agent for executing multiple APIs simultaneously in parallel or in sequence. The API agent performs a vector database similarity search using embeddings representing a user query and a plurality of candidate APIs to identify one or more relevant APIs for responding to the user query. The API agent utilizes a large language model (LLM) API orchestrator for performing dynamic slot filling to replace missing API parameters required for calling one or more of the relevant APIs. The API agent executes the query on the relevant APIs to obtain response data from the relevant APIs. The response data is filtered and combined into a single query response which is provided to a user in response to the query.

### BACKGROUND

In a task-based environment, many business applications have many application programming interfaces (APIs) to call for a given user query. This can be a tedious task for traditional systems which can struggle with generalizations. It can also be a cumbersome and error prone task of scaling intents, entities, and dialog management flows.

### SUMMARY

Some embodiments provide a system and method for an autonomous application programming interface (API) agent. The API agent receives a query associated with a request for information from a user via a user interface (UI) device. The API agent performs a vector database similarity search using a vectorized search query associated with the query and a plurality of application programming interface (API) candidates. The API agent identifies one or more relevant APIs from the plurality of API candidates using vector database similarity search results. The API agent includes a large language model (LLM) API orchestrator. The LLM API orchestrator executes the query on the one or more relevant APIs by a large language model (LLM) API orchestrator. A response is received from each relevant API. The API agent filters the response data from the response received from each API. Extraneous information is filtered from the API response data. The API agent generates a query response using the remaining unfiltered response data from each response in the API responses received from each API in the set of relevant APIs. The query response is a single response including relevant data from one or more APIs presented to the user via the UI device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for an autonomous application programming interface (API) enabling multi-API calling.

FIG. 2 is an exemplary block diagram illustrating a system utilizing vector database similarity search to identify relevant APIs.

FIG. 3 is an exemplary block diagram illustrating a system for vectorization of candidate APIs for use in vector database similarity searches.

FIG. 4 is an exemplary block diagram illustrating a system including an API agent executing multiple APIs autonomously.

FIG. 5 is an exemplary block diagram illustrating an API agent for multi-API execution serially or in parallel.

FIG. 6 is an exemplary flow chart illustrating operation of the computing device to perform API calling by an API agent using vector database similarity search.

FIG. 7 is an exemplary flow chart illustrating operation of the computing device to perform dynamic slot filling.

FIG. 8 is an exemplary flow chart illustrating operation of the computing device to execute relevant APIs in response to user queries by an autonomous API agent.

FIG. 9 is an exemplary diagram illustrating a user interface API agent query page.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Developers frequently need to update traditional API orchestrator components to support new application programming interfaces and update data flows for all new tasks. For conversational artificial intelligence (AI) systems, users typically have to retrain the orchestrator for each new API and/or each new user or entity intent. If a system includes a pool of ten APIs, then ten API agent component are typically required to call each of those APIs. This is a slow, tedious, and laborious process which limits scalability. Moreover, these systems frequently also lack accuracy in analyzing and discerning user intents from an input user query. This results in higher error rates and wasted resources consumed in generating inaccurate or undesirable response data.

In a task based environment, business applications can have many APIs at their disposal. Traditional systems frequently struggle to accurately identify a related API to call for a given user query, understand its required parameters, and parse a received API response as part of data formatting between services. This is often a tedious task for traditional systems which struggle with generalization leading to failure to respond to user queries adequately and accurately in these settings.

Referring to the figures, examples of the disclosure enable an autonomous application programming interface (API) agent. In some examples, the API agent utilizes vector embeddings representing a user query and a plurality of candidate APIs to identify one or more relevant APIs for responding to the user query. This enables faster and more accurate identification of APIs while reducing system resources consumed during API calling, such as, but not limited to, reducing processor usage, reducing network bandwidth usage, and reducing memory usage expended during API calling.

Aspects of the disclosure further enable calling of multiple APIs simultaneously in parallel or in sequence by a single API agent. Instead of creating a specific API agent for calling each different API in a pool of candidate APIs, the autonomous API agent includes a LLM component enabling a single API agent to be trained for calling multiple different APIs. This reduces the number of API agent components required for calling multiple APIs.

The computing device operates in an unconventional manner by utilizing an LLM API orchestrator and a vector database similarity search to identify and execute multiple APIs simultaneously for responding to user queries in a faster and more efficient manner while reducing system resource usage. In this manner, the computing device is used in an unconventional manner and allows improved identification of relevant APIs and execution of multiple APIs simultaneously in parallel by a single API agent rather than requiring a different API agent for each different API, thereby improving the functioning of the underlying computing device.

In other embodiments, if a user query requires calling of multiple APIs to respond to the user query, the system is able to filter, edit and combine the responses received from multiple APIs into a single response which is provided to a user via a UI device. This enables improved user efficiency via the UI interface and increased user interaction performance.

The system, in some embodiments, enables generative artificial intelligence (Gen AI) based task completion via an autonomous API Agent. The API agent performs multiple API inference for handling multiple API calls in parallel/simultaneously and parameter (Slot) filling to add missing parameters using context provided in the query and/or by prompting the user in real-time to provide information missing from the query. A secured LLM API orchestrator supports multiple sequential and parallel API calls to answer a single user query. In this manner, the API Agent is versatile and capable of interfacing with any API. The system is easily scalable and expandable to accommodate different APIs. The APIs operate seamlessly in this setting. The system reduces model training and improves handling of multiple APIs and enables simple onboarding of new APIs.

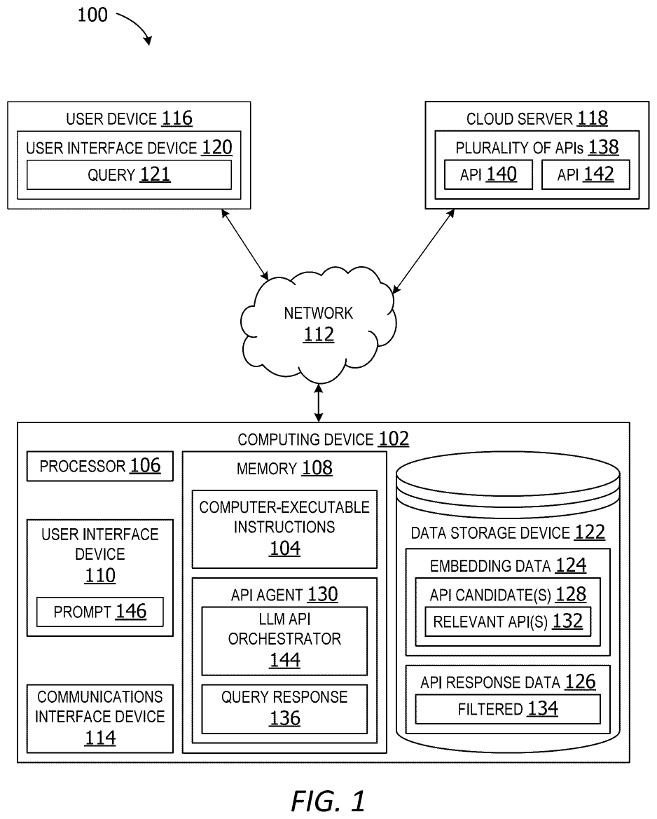

Referring again to FIG. 1, an exemplary block diagram illustrates a system 100 for autonomous application programming interface (API) enabling multi-API calling. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

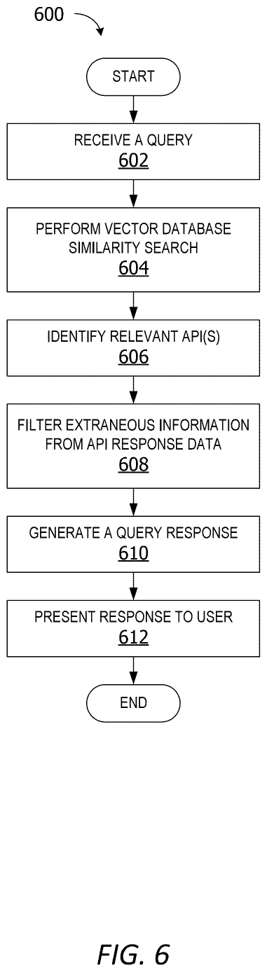

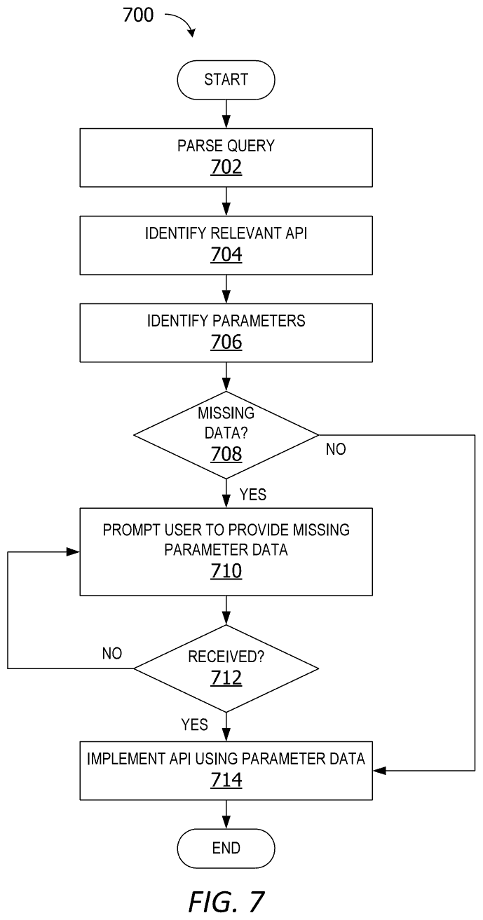

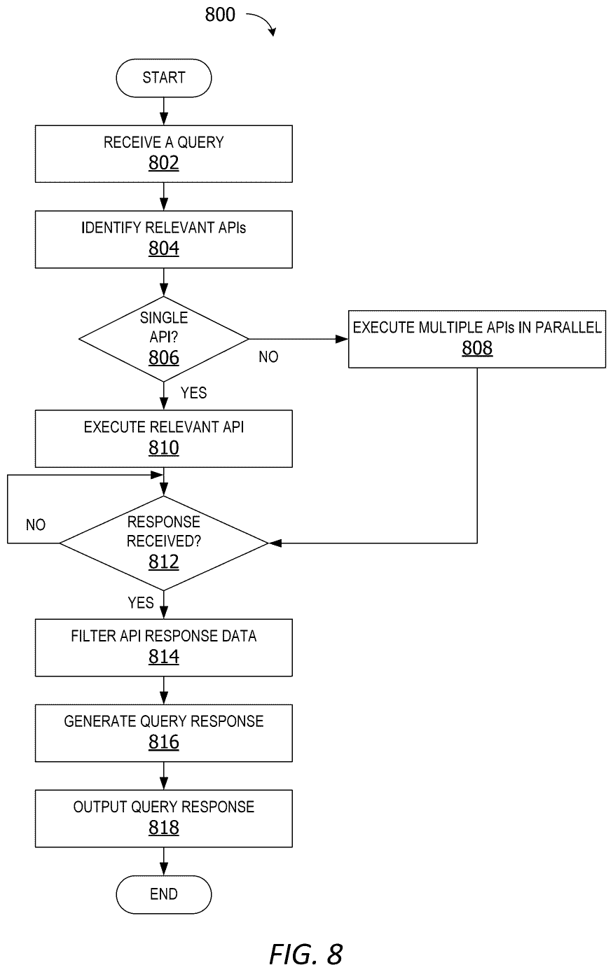

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 6, FIG. 7, and FIG. 8).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device 120.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 122 for storing data, such as, but not limited to embedding data 124 and/or API response data 126. The embedding data 124 is data associated with a query 121 converted into vectors (vectorized query) received from a user and/or vectorized candidate API data. The query 121 is used to generate a vector embedding representing the query 121. A vector embedding is a vector value or numerical representation of a data item, such as the query or an API description associated with one or more candidate API(s) 128. An API agent 130 is a software component that utilizes the embedding data 124, including the vector embeddings for the query 121 and the candidate API(s) 128, to identify one or more relevant API(s) 132. A relevant API is an API identified as being relevant to a specific query, such as the query 121. The API agent 130 uses a vector database similarity search to identify relevant APIs for generating a response to a given user query, such as the query 121.

The API response data 126 is data associated with response data received from one or more API(s) in response to the API agent calling one or more API(s). The API response data 126, in some examples, is filtered 134 to remove extraneous data that is not needed or irrelevant to the query 121. For example, if a query is requesting a current price of an item, any quantity data associated with a number of units of the item is irrelevant or extraneous information unnecessary for responding to the query. The extraneous information is filtered out to streamline the final query response 136 which is generated and provided to a user in response to the query 121.

The data storage device 122 can include one or more different types of data storage devices, such as, for example, one or more rotating disks drives, one or more solid state drives (SSDs), and/or any other type of data storage device. The data storage device 122 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 122 includes a database.

The data storage device 122 in this example is included within the computing device 102, attached to the computing device, plugged into the computing device, or otherwise associated with the computing device 102. In other examples, the data storage device 122 includes a remote data storage accessed by the computing device via the network 112, such as a remote data storage device, a data storage in a remote data center, or a cloud storage.

The memory 108 in some examples stores one or more computer-executable components, such as the API agent 130. The API agent 130 component, when executed by the processor 106 of the computing device 102, receives a query 121 associated with a request for information from a user via the user interface (UI) device 120. The API agent 130 performs a vector database similarity search using the embedding data 124, including vectorized search query associated with the query 121 and a plurality of APIs 138, such as a first API 140 and/or a second API 142. The API 138 and the API 140 are candidate APIs available for utilization in responding to user queries, such as, but not limited to, the user query 121.

In some embodiments, the API agent identifies a set of one or more relevant APIs 132 from the API candidate(s) 128 using vector database similarity search results, including API response data 126. The results are filtered 134 to remove extraneous data.

The API agent 130, in some embodiments, includes a large language model (LLM) API orchestrator 144. The LLM API orchestrator 144 is a trained machine learning (ML) model. The LLM API orchestrator 144 executes the query on the set of one or more relevant API(s) 132. The API agent 130 filters the API response data 126 received from each of the relevant APIs in the set of relevant APIs. The API agent 130 generates a single, unified query response 136, including all the relevant (unfiltered) data from the API response data 126 received from one or more relevant APIs. In other words, the remaining unfiltered data from each response in the API responses received from each API in the set of relevant APIs is used by the API agent 130 to generate a single response to the user query 121. The query response 136 is presented to the user via the UI device.

In other embodiments, if the query 121 does not include all the information needed to execute one or more of the relevant API(s) 132, the API agent 130 generates a prompt 146 which is presented to the user via a user interface, such as, but not limited to, the user interface device 110 and/or the user interface device 120. The prompt 146 is a request for the user to provide missing information, such as information associated with a parameter required to execute an API. The information received back from the user in response to the prompt 146 is utilized to dynamically fill in missing parameter information needed to call one or more of the relevant APIs.

The API agent 130 shown in FIG. 1 is implemented on a computing device. However, the embodiments are not limited to implementing the API agent 130 on a computing device. In other examples, the API agent 130 is implemented on a cloud server, such as, but not limited to, the cloud server 118.

In this example, the LLM API orchestrator 144 is integrated into the API agent 130. However, the embodiments are not limited to implementing the LLM API orchestrator in the API agent. In other embodiments, the LLM API orchestrator 144 is implemented as a separate component from the API agent. In these examples, the API agent is communicatively coupled with the LLM API orchestrator 144. In some embodiments, the LLM API orchestrator 144 is a generative artificial intelligence (Gen AI) model.

The API agent 130 and the LLM API orchestrator 144 are optionally implemented on the same computing device, such as, but not limited to, the computing device 102 as shown in FIG. 1. However, in other embodiments, the LLM API orchestrator and API agent are implemented on separate computing devices. In these examples, the API agent exchanges data with the LLM API orchestrator via a network, such as, but not limited to, the network 112.

In some embodiments, the API Agent 130 handles the API calling from API Pool based on a user query (question), offering control over authentication and authorization for any API calls. The framework dynamically fills in missing parameters if the parameter information can be extracted from the query context. In other embodiments, the API agent 130 prompts the user to provide the necessary parameters, such as the location of a store. The system is capable of making multiple sequential (step-by-step) and parallel API calls to answer user queries. For example, the system can make multiple API calls to answer a single user query as well as make multiple API calls simultaneously to answer multiple different user queries.

The API agent 130 leverages large language models (LLMs), such as the LLM API orchestrator, to answer user queries, understand API required parameters, and parse API responses as part of data formatting between services.

For a given user query, the API agent 130 finds relevant APIs from a given collection of available APIs. This is done through a vector database similarity search. The API agent 130 executes the query over relevant APIs and performs parameter filling using LLM function calling features. The API agent 130 hands API authentication and authorization. The API agent 130 handles dynamic API parameter filling. If the required API parameters are not present in a given initial user query, the API agent 130 asks a follow up user questions prompting the user to provide additional input (missing information) for the required parameter values that are missing.

The API agent 130, in some embodiments, use a probabilistic approach to predict the next word in a sequence to LLMs based of transformer architecture that are trained on massive datasets. This enables them to recognize, translate, predict, or generate text or other content. The API Agent 130 selects the top “N” number of relevant APIs to use to answer queries. The top “N” number of relevant APIs is a user configurable value. This is useful in case of many APIs to select from. The system does not include every API information to GPT function calling due to context length and cost so instead it dynamically selects the N=3 APIs to consider using at run time. This is based on Lang Chain Custom agent with tool retrieval. The API Agent leverages vector database similarity search to retrieve relevant API details.

Once the vector database provides the top relevant API records for a given query, these API records are passed along with the query to Open AI function calling (function-calling, n.d.) feature to select the function to call and returns the extracted parameter values. If all the required parameters for the API are extracted, then the system performs the API inference with parameters. Otherwise, it prompts the user for the API required parameters. Later, the LLM parses the API response and returns the final query response to the user.

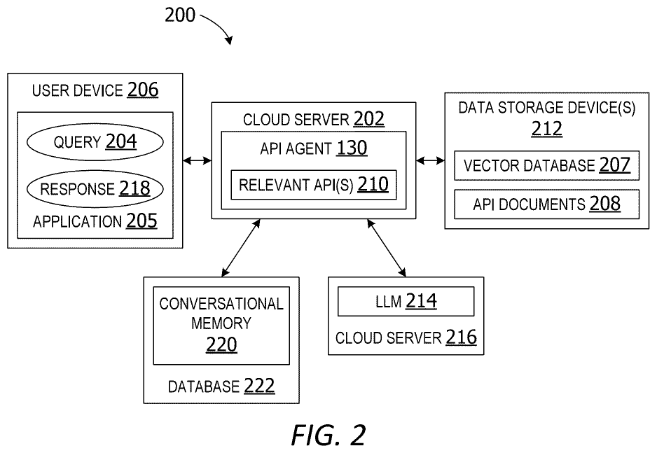

FIG. 2 is an exemplary block diagram illustrating a system 200 utilizing vector database similarity search to identify relevant APIs. In some embodiments, an API agent 130 is implemented on a cloud server, such as, but not limited to, a cloud server 202. The cloud server 202 is a cloud server such as, but not limited to the cloud server 118 in FIG. 1. The API agent 130 receives a query 204 from a user device 206. The user device is a computing device, such as, but not limited to, the user device 116 in FIG. 1. The query 204 is a natural language input provided by a user. The query 204 can be entered as typed text, spoken verbal input via a speaker, written text entered via an uploaded image captured by a camera or other image capture device, etc. However, the embodiments are not limited to receiving a query from a user device. The query can be received from any type of computing device and/or a cloud server in other embodiments.

The query 204 is a user query generated via an application 205. The query 204, in this example, is entered via a text field presented on a UI on the user device 206, such as, but not limited to, the user interface device 110 and/or the user interface device 120 in FIG. 1. The API agent 130 performs a vector database 207 similarity search using embeddings representing the query 204 and/or embeddings representing candidate APIs. A candidate API is an API in the pool of available APIs which can be called by the API agent. The pool of available APIs which the API agent can consume can include two or more APIs. For example, the pool of available APIs can include five APIs, ten APIs or any other number of APIs.

API documents 208 include instructions describing one or more candidate APIs, such as, but not limited to, the plurality of APIs 138. The results of the similarity search are used to identify relevant API(s) 210. The API documents 208 optionally include references, tutorials, and/or other information to assist the API agent 130 in using and integrating one or more APIs.

In some embodiments, the API documents 208 include a description of each API within the pool of available APIs which can be called by the API agent 130. API documents 208 include a description of the API, required parameters, and other API-specific information. The vector database 207 and/or the API documents 208 are stored in a data storage device 212. The data storage device 212 is a device, such as, but not limited to, the data storage device 122 in FIG. 1.

The vector database 207 is a database for storing vector embeddings, such as embeddings representing user queries, such as, but not limited to, the query 204. The vector database 207 also includes embeddings representing API description data describing available APIs in the pool of APIs, such as, but not limited to, the API description data included in the API documents 208.

The API agent 130, in some embodiments, utilizes a LLM 214 hosted on a cloud server 216, such as, but not limited to, the cloud server 118 in FIG. 1. The LLM 214 is a large language model trained to identify relevant API(s) 210 and/or filter API response data received from each relevant API in response to the API agent 130 implementing the query 204 on the relevant API. In other embodiments, the LLM 214 is trained to authorize and/or authenticate each API in the pool of APIs using authentication data, such as, but not limited to, user login information and/or other user credentials. The pool of APIs includes a plurality of available APIs, such as, but not limited to, the plurality of APIs 138 in FIG. 1. The LLM 214 is a machine learning (ML) model, such as, but not limited to, the LLM API orchestrator 144.

The API agent 130 filters the responses received from each relevant API in the set of one or more relevant API(s) 210. The API agent 130 generates a single unified response 218 to the original user query 204. The response 218 is presented to the user via a UI, such as, but not limited to, a UI on the user device 206. In this example, the cloud server 202 transmits the response 218 to the user device 206 via a network, such as, but not limited to, the network 112 in FIG. 1.

The API agent 130 stores conversational data as conversational memory 220 in a database 222. The conversational memory 220 includes a record of each query received by the API agent and each response generated by the API agent. The conversational memory 220 optionally also includes data associated with dynamic prompts output to the user requesting additional information for slot filling. Slot filling refers to dynamically obtaining missing parameter information for API parameters needed to successfully call a given API. In some embodiments, the system retains the conversation history in the conversational memory 220 for use in performing analytics and evaluating performance of the API agent.

In this example, the API agent 130 is implemented on a first cloud server 202 and the LLM 214 is implementedon a second cloud server 216. However, the embodiments are not limited to implementing the API agent and the LLM on separate cloud servers. In other embodiments, the API agent 130 and the LLM 214 are implemented on the same computing device, as shown in FIG. 1 above.

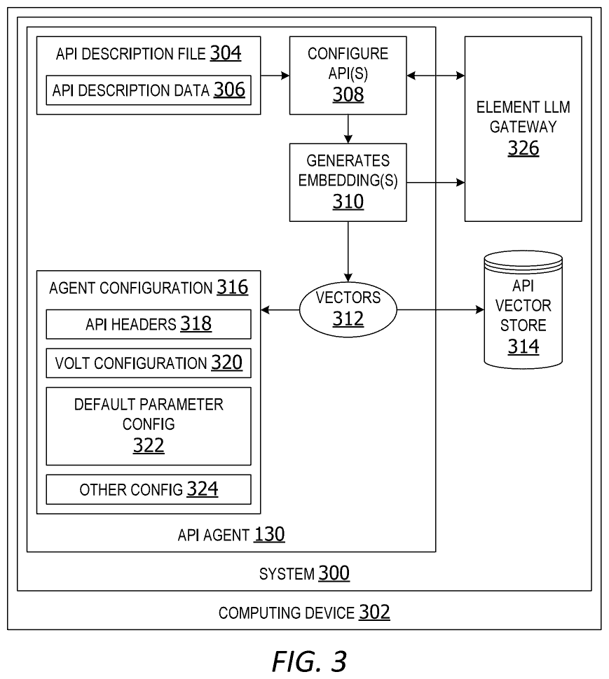

Referring now to FIG. 3, an exemplary block diagram illustrating a system 300 for vectorization of candidate APIs for use in vector database similarity searches is shown. The computing device 302 is a device, such as, but not limited to, the computing device 102 and/or the user device 116 in FIG. 1. In this example, an API description file 304 includes one or more API documents or records containing API description data 306, such as, but not limited to, the API documents 208 in FIG. 2.

The API description file 304 is used to configure one or more API(s) 308. The API agent 130 generates one or more embedding(s) 310 representing the API(s). The embedding(s) include vectors representing each API. The vectors 312 are stored in an API vector store 314, such as, but not limited to, the vector database 207.

In some embodiments, the API agent configuration 316 is performed enabling the API agent to identify relevant APIs by performing a vector database similarity search. The configuration includes configuring API headers 318, volt configuration 320, default parameter configuration 322, and/or any other configuration 324.

In this example, the API agent 130 utilizes an element LLM gateway 326 for communications between the API agent and the LLM API orchestrator, such as, but not limited to, the LLM API orchestrator 144 in FIG. 1. The element LLM gateway 326 enables the API agent 130 to route requests to the LLM API orchestrator and/or receive responses from the LLM API orchestrator.

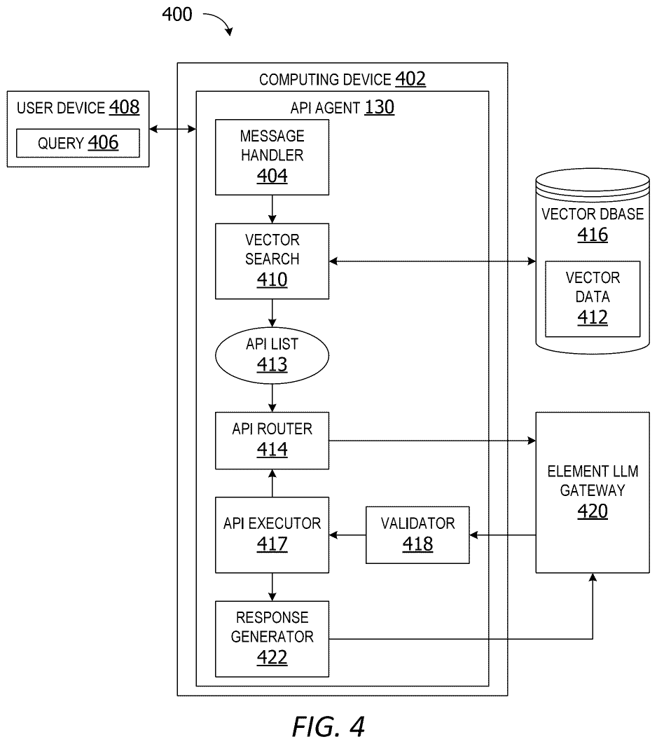

FIG. 4 is an exemplary block diagram illustrating a system 400 including an API agent executing multiple APIs autonomously. An API agent 130 on a computing device 402 in some examples, includes a message handler 404. The message handler 404 receives a user query 406 from a user device 408. The computing device 402 is a device, such as, but not limited to, the computing device 102 and/or the user device 116 in FIG. 1. The user device 408 is a device such as, but not limited to, the computing device 102 and/or the user device 116.

The message handler 404 triggers a vector search 410 using vector data 412 stored on a vector database 416. The vector database 416 is a database for storing vector embeddings representing a query and/or one or more candidate APIs, such as, but not limited to, the vector database 207 in FIG. 2 The vector embeddings include embeddings data, such as, but not limited to, the embedding data 124 in FIG. 1. The similarity search is performed to identify the API embeddings which have the closest similarity (nearest neighbor/shortest distance) with the vector embedding representing the query 406. The API agent 130 generates an API list 413 including one or more relevant API(s) which are most relevant to the query 406.

A relevant API is an API that is semantically similar to the query based on a description of the API. In some embodiments, the best “N” number of APIs are selected based on a description of each candidate API in the pool of APIs. The number of APIs selected is a user configurable value. The number of APIs can be a single API as well as two or more APIs. In some examples, a user query cannot be thoroughly responded to using information from a single API. In such cases, the system selects the best API that is most similar to a portion of the query and a best API that is most similar to another portion of the query.

An API executor 417 utilizes an API router 414 to execute the query 406 over the relevant API(s) in the API list 413. A validator 418 performs authentication and authorization enabling access to the relevant API(s). In some examples, the API agent 130 access an element LLM gateway 420 to access one or more LLMs, such as, but not limited to, the element LLM gateway 326 in FIG. 3.

A response generator 422 is a software component for generating a query response which is output to the user device 408 in response to the query 406. The response generator 422 utilizes response data received from one or more relevant APIs to generate the final response output to the user via the user device 408.

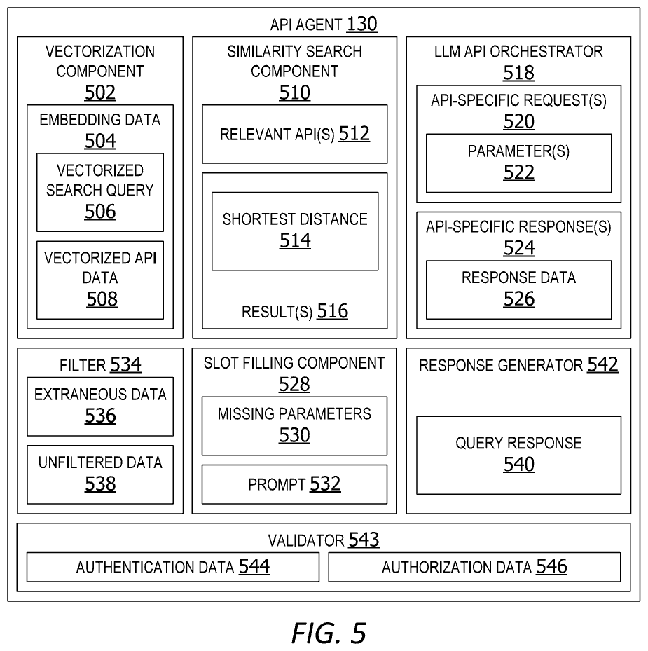

FIG. 5 is an exemplary block diagram illustrating an API agent 130 for multi-API execution serially or in parallel. In some embodiments, a vectorization component 502 generates embedding data 504. The embedding data 504 includes vectorized search query 506 and/or vectorized API data 508. The vectorized search query 506 is a vector embedding representing a query received by a message handler, such as, but not limited to, the message handler 404 in FIG. 4. The vectorized API data 508 includes one or more vector embeddings representing one or more candidate APIs in a plurality of APIs available in an API pool.

In other embodiments, a similarity search component 510 performs a similarity search using the embedding data 504. The result(s) 516 of the similarity search identify one or more relevant API(s) 512 having a shortest distance 514 (closest similarity) to the query. In some examples, the relevant API(s) 512 includes a single API capable of providing all the information required to respond to the query adequately and fully. In other examples, the relevant API(s) 512 include two or more APIs which provide different types of information needed to generate a complete and accurate response to the query.

An LLM API orchestrator 518 is a trained ML model which generates one or more API-specific request(s) 520 for information from the one or more relevant API(s) 512. The API-specific request(s) include one or more parameter(s) 522. The LLM API orchestrator 518 calls the relevant API(s) using the API-specific request(s) 520, which are transmitted to the relevant API(s). In response, the API agent 130 receives API-specific response(s) 524 from the relevant API(s) 512. The API-specific response(s) 524 include response data 526. The response data 526 includes relevant data needed to respond to the query as well as irrelevant (extraneous) information which is not needed to respond to the query.

In some embodiments, the LLM API orchestrator 518 analyzes information provided in the query with API-specific information identifying parameter(s) needed to call each API. The APIs in the pool of candidate APIs can have multiple different combinations of parameters required for function calling. The LLM API orchestrator 518 identifies any missing parameter(s) 522 for each API. A slot filling component 528 generates a prompt 532 which is displayed to the user via a UI on a user device, such as, but not limited to, the user device 116 in FIG. 1. The prompt 532 requests information needed to fill in the missing parameters 530 required to call a specific API using the API-specific request(s) 520. If the user provides the requested information in response to the prompt 532, the slot filling component 528 automatically and dynamically provides the missing parameters in the requests.

For example, a user query can request current availability of a particular product at a store near the customer requires a city for the customer. If the query does not include the city information, that parameter is missing. In this example, the system prompts the user to provide the customer's city information. Once the city information is provided, the system passes the “city” parameter to the API. The response received back can include the availability of the product in addition to other extraneous information, such as product pricing, aisle location, etc. The system filters the extraneous data from the response.

Once responses are received from the one or more relevant API(s) 512, a filter 534 optionally filters extraneous data 536 from each response received from each of the relevant APIs called by the API agent 130. A response generator 542 uses the unfiltered data 538 remaining after removal of the extraneous data 536 is used to generate a properly formatted query response 540. The response generator 542 is a component for generating a single unified query response using response data received from one or more relevant APIs, such as, but not limited to, the response generator 422 in FIG. 4. In some embodiments, the response generator 542 uses the response data received from two or more APIs to generate a single unified response which is output to the user.

In other embodiments, the API agent 130 optionally includes a validator 543. The validator 543 is a component for authenticating and/or authorizing utilization of each API, such as, but not limited to, the validator 418 in FIG. 4. In this example, the validator 543 includes authentication data 544 and/or authorization data 546 for authenticating the API agent and/or authorizing access to a specific API. Authentication data 544 includes data associated with authenticating an individual, application, or service attempting to utilize functions and/or resources of an application or other digital service. Authentication data can include data, such as, but not limited to, username, password, biometric information, and/or login credentials. Authorization data 546 is data associated with determining which services, actions, and/or resources an individual, application or other digital service is entitled to access.

Turning now to FIG. 6, an exemplary flow chart illustrating operation of the computing device to perform API calling by an API agent using vector database similarity search is shown. The process 600 shown in FIG. 6 is performed by an API agent component, executing on a computing device, such as the computing device 102 or the user device 116 in FIG. 1.

The process begins by receiving a query at 602. The query is a user query, such as, but not limited to, the query 121 in FIG. 1. The query is input via a user interface, such as, but not limited to, the user interface device 110 and/or the user interface device 120 in FIG. 1. An API agent performs a vector database similarity search at 604. The similarity search is performed using embedding data associated with the query and a plurality of candidate APIs. The candidate APIs are APIs which are available and can be executed to obtain information needed to generate a relevant response to the query. The API agent identifies one or more relevant API(s) at 606. The API agent filters extraneous information from API response data at 608. The API agent generates a query response at 610. The query response is presented to a user at 612. In some embodiments, the query response is presented via a UI, such as, but not limited to, the user interface device 110 and/or the user interface device 120 in FIG. 1. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to perform dynamic slot filling. The process 700 shown in FIG. 7 is performed by an API agent component, executing on a computing device, such as the computing device 102 or the user device 116 in FIG. 1.

The process begins by parsing a query at 702. The query is a user query, such as, but not limited to, the query 121. The API agent identifies a relevant API at 704. A relevant API is an API having a description that is identified as contextually similar to the query based on results of a vector database similarity search. The API agent identifies parameters needed for a call to the relevant API ta 706. A determination is made whether an y parameter data is missing at 708. If not, the AP is implemented using the parameter data at 714. If data is missing, the API agent prompts the user to provide the missing parameter data at 710. A determination is made whether the missing parameter data is received from the user at 712. If not, the system prompts the user until a response is received. When missing parameter data is received at 712, the API agent implements the relevant API using the parameter data at 714. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

FIG. 8 is an exemplary flow chart illustrating operation of the computing device to execute relevant APIs in response to user queries by an autonomous API agent. The process 800 shown in FIG. 8 is performed by an API agent component, executing on a computing device, such as the computing device 102 or the user device 116 in FIG. 1.

The process begins by receiving a query at 802. Relevant APIs are identified at 804. The API agent determines whether a single API is relevant at 806. If yes, the relevant API is executed at 810. A determination is made whether a response is received from the relevant API at 812. When a response is received, the API agent filters the API response data at 814. The response is filtered to remove unnecessary information. The API agent generates a query response at 816. The query response is output to the user at 818. The process terminates thereafter.

If two or more relevant APIs are identified at 806, the API agent executes multiple APIs in parallel at 808. In this example, the API agent simultaneously calls two or more APIs. The API agent determines whether a response is received from all the relevant APIs at 812. When all the responses are received at 812, the response data is filtered at 814. The API agent generates a single query response using the filtered response data at 814. The query response is output at 818. The response includes unfiltered information remaining after removal of the extraneous information from the response data received from each of the relevant APIs. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

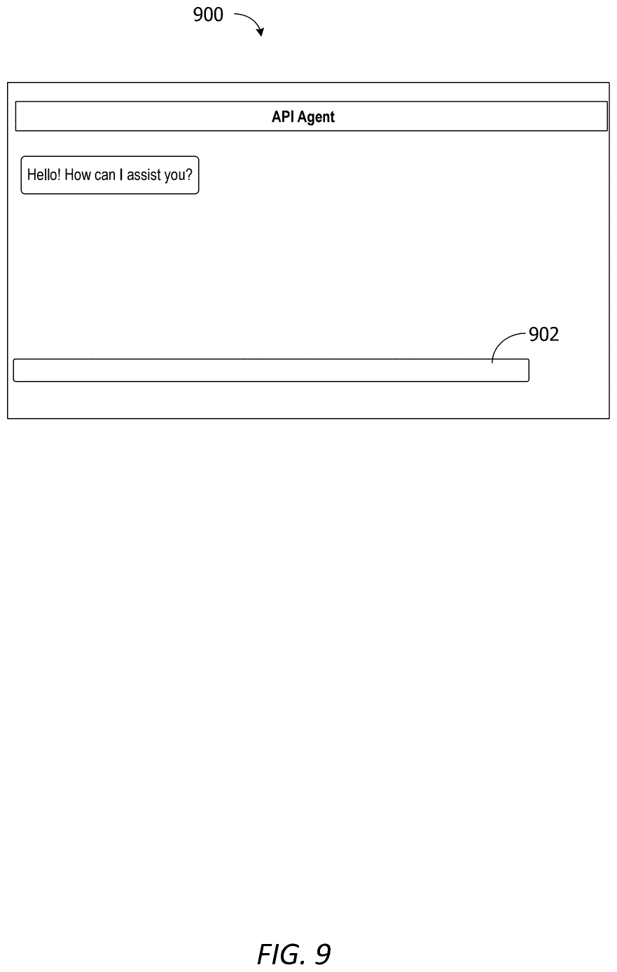

FIG. 9 is an exemplary diagram illustrating a user interface displaying an API agent query page 900. In this non-limiting example, the API agent query page includes a text field 902 for inputting a user query. The user query is input via a text format in this example. However, the embodiments are not limited to inputting a user query via a text format. In other examples, a user inputs a query as a natural language verbal input, such as via words spoken into a speaker device. In other examples, the query is input via an image of a printed or typed query. The image is generated by an image capture device, such as a camera.

### Additional Examples

For a given user query, in some embodiments, the autonomous API agent finds relevant APIs from a given collection of APIs. This is done through vector database similarity search. The API Agent then executes the query over relevant APIs and performs the parameter filling using LLM function calling feature. In this manner, the system acts as secured multi-API orchestrator, capable of handling the different APIs authentication and authorization.

In some embodiments, the API agent handles dynamic API parameter filling where the required API parameters are absent from (not present) an initial user query. The API agent asks a follow up user question prompting the user to provide the missing required parameters values. The system further supports multiple sequential and parallel API calls to answer a single user query.

The system, in other embodiments, includes a secured LLM API orchestrator application that handles API calling from an API Pool based on a user question (query), offering control over authentication and authorization for any API calls.

Dynamic parameter (slot) filling, in some embodiments, enables missing parameters to be added dynamically if the information is present in the context. If there is missing information unavailable from the context of the query, the system can prompt the user to provide the necessary parameters.

This framework is versatile, capable of interfacing with any API, and easily expandable to accommodate different APIs. The system is capable of making multiple sequential (step-by-step) and parallel API calls to answer user queries. The API agent leverages one or more LLMs to answer user queries.

The API agent enables cost saving by reducing the average handle time (AHT) for user queries and improves customer satisfaction by providing more accurate and complete responses to queries. The API agent can be utilized with chatbots, handling tasks and knowledge-based customer queries. This feature further improves the current chatbots conversation rates. The API Agent further aids in automating merchandising inquiries. Customers engage agents through either chat or phone regarding the availability of items. The API Agent can extract item information and infer APIs to understand if a requested item identified in the user query is available.

In an example scenario, the system identifies the top “K” nearest neighbor APIs for a given query. In this example, the system identifies four APIs. The system then performs similarity search using the vectorization data (embeddings) to identify the API that is the closest or most similar to the query from the previously identified four APIs.

In some embodiments, the system provides a different mechanism for API calling through conversational AI platform, where LLMs are trained to understand the intent and entities associated with input queries and call functions based on it. Moreover, scalability of the system enables expansion or modification by adding or removing microservices via updates to API configuration files.

Alternatively, or in addition to the other examples described herein, examples include any combination of the following:
execute the query on multiple APIs in the set of relevant APIs simultaneously in parallel to respond to a single user query;
execute the query on multiple APIs in the set of relevant APIs simultaneously in sequence to respond to a single user query;
identify a missing parameter for executing the query on a given API in the set of relevant APIs;
prompt the user to input the missing parameter via the UI device;
perform dynamic slot filling to add the missing parameter prior to executing the query on the given API;
perform authentication for each API in the set of relevant APIs by the LLM API orchestrator;
store conversation history associated with the query in a data storage device for use in performing analytics;
receive a first query and a second query via the UI device;
perform a first vector database similarity search to identify a first API relevant to the first query and a second vector database similarity search to identify a second API relevant to the second query;
execute the first API and the second API simultaneously in parallel;
generate a first query response using a first response data received from the first API and a second query response data using a second response received from the second API.

At least a portion of the functionality of the various elements in FIG. 1, FIG. 2, FIG. 3, FIG. 4, and FIG. 5 can be performed by other elements in FIG. 1, FIG. 2, FIG. 3, FIG. 4, and FIG. 5, or an entity (e.g., processor 106, web service, server, application program, computing device, etc.) not shown in FIG. 1, FIG. 2, FIG. 3, FIG. 4, and FIG. 5.

In some examples, the operations illustrated in FIG. 6, FIG. 7, and FIG. 8 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method for an autonomous API agent, the method comprising receive a query associated with a request for information from a user via a user interface (UI) device; performing a vector database similarity search using a vectorized search query associated with the query and a plurality of application programming interface (API) candidates; identifying a relevant API from the plurality of API candidates using vector database similarity search results; executing the query

on the relevant API by a LLM API orchestrator; filtering an API response received from the relevant API, by the LLM API orchestrator, wherein extraneous information is filtered from the API response; and generating a query response using unfiltered data from the API response, wherein the query response is presented to the user via the UI device.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for autonomous API agent enabling multi-API calls. For example, the elements illustrated in FIG. 1, FIG. 2, FIG. 3, FIG. 4, and FIG. 5, such as when encoded to perform the operations illustrated in FIG. 6, FIG. 7, and FIG. 8, constitute exemplary means for receiving a query associated with a request for information from a user via a user interface (UI) device; exemplary means for performing a vector database similarity search using a vectorized search query associated with the query and a plurality of application programming interface (API) candidates; exemplary means for identifying a set of relevant APIs from the plurality of API candidates using vector database similarity search results; exemplary means for executing the query on the set of relevant APIs by a large language model (LLM) API orchestrator; exemplary means for filtering API responses received from each API in the set of relevant APIs, by the LLM API orchestrator, wherein extraneous information is filtered from the API responses; and exemplary means for generating a query response using unfiltered data from each response in the API responses received from each API in the set of relevant APIs, wherein the query response is presented to the user via the UI device.

Other non-limiting examples provide one or more computer storage devices having a first computer-executable instructions stored thereon for providing an autonomous API agent. When executed by a computer, the computer performs operations including receiving a query associated with a request for information from a user via a user interface (UI) device; performing a vector database similarity search using a vectorized search query associated with the query and a plurality of application programming interface (API) candidates; identifying a set of relevant APIs from the plurality of API candidates using vector database similarity search results; executing the query on the set of relevant APIs by a large language model (LLM) API orchestrator; filtering API responses received from each API in the set of relevant APIs, by the LLM API orchestrator, wherein extraneous information is filtered from the API responses; and generating a query response using unfiltered data from each response in the API responses received from each API in the set of relevant APIs, wherein the query response is presented to the user via the UI device.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” only one of′ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for calling multiple application programming interfaces (APIs) via an autonomous API agent, the system comprising:
a processor; and
a computer-readable medium storing instructions that are operative upon execution by the processor to:
receive a query associated with a request for information from a user via a user interface (UI) device;
perform a vector database similarity search using a vectorized search query associated with the query and a plurality of application programming interface (API) candidates;
identify a set of relevant APIs from the plurality of API candidates using vector database similarity search results;
execute the query on the set of relevant APIs by a large language model (LLM) API orchestrator;
filter API responses received from each API in the set of relevant APIs, wherein extraneous information is filtered from the API responses; and
generate a query response using unfiltered data from each response in the API responses received from each API in the set of relevant APIs, wherein the query response is presented to the user via the UI device.

2. The system of claim 1, wherein the instructions are further operative to:
execute the query on multiple APIs in the set of relevant APIs simultaneously in parallel to respond to a single user query.

3. The system of claim 1, wherein the instructions are further operative to:
execute the query on multiple APIs in the set of relevant APIs simultaneously in sequence to respond to a single user query.

4. The system of claim 1, wherein the instructions are further operative to:
identify a missing parameter for executing the query on a given API in the set of relevant APIs;
prompt the user to input the missing parameter via the UI device; and
perform dynamic slot filling to add the missing parameter prior to executing the query on the given API.

5. The system of claim 1, wherein the instructions are further operative to:
perform authentication for each API in the set of relevant APIs by the LLM API orchestrator.

6. The system of claim 1, wherein the instructions are further operative to:
store conversation history associated with the query in a data storage device for use in performing analytics.

7. The system of claim 1, wherein the instructions are further operative to:
receive a first query and a second query via the UI device;
perform a first vector database similarity search to identify a first API relevant to the first query and a second vector database similarity search to identify a second API relevant to the second query;
execute the first API and the second API simultaneously in parallel; and
generate a first query response using a first response data received from the first API and a second query response data using a second response received from the second API.

8. A method for multi-API calling via an autonomous API agent, the method comprising:
receive a query associated with a request for information from a user via a user interface (UI) device;
performing a vector database similarity search using a vectorized search query associated with the query and a plurality of API candidates;
identifying a relevant API from the plurality of API candidates using vector database similarity search results;
executing the query on the relevant API by a LLM API orchestrator;
filtering an API response received from the relevant API, by the LLM API orchestrator, wherein extraneous information is filtered from the API response; and
generating a query response using unfiltered data from the API response, wherein the query response is presented to the user via the UI device.

9. The method of claim 8, further comprising:
executing the query on multiple APIs simultaneously in parallel to respond to a single user query.

10. The method of claim 8, further comprising:
executing the query on multiple APIs simultaneously in sequence to respond to a single user query.

11. The method of claim 8, further comprising:
identifying a missing parameter for executing the query on the relevant API;
prompting the user to input the missing parameter via the UI device; and
performing dynamic slot filling to add the missing parameter prior to executing the query on the relevant API.

12. The method of claim 8, further comprising:
performing authentication for each API in the plurality of API candidates by the LLM API orchestrator.

13. The method of claim 8, further comprising:
storing conversation history associated with the query in a data storage device for use in performing analytics.

14. The method of claim 8, further comprising:
receiving a first query and a second query via the UI device;
performing a first vector database similarity search to identify a first API relevant to the first query and a second vector database similarity search to identify a second API relevant to the second query;
executing the first API and the second API simultaneously in parallel; and
generating a first query response using a first response data received from the first API and a second query response data using a second response received from the second API.

15. One or more computer storage devices having computer-executable instructions stored thereon, which, upon execution by a computer, cause the computer to perform operations comprising:
receiving a query associated with a request for information from a user via a user interface (UI) device;
performing a vector database similarity search using a vectorized search query associated with the query and a plurality of API candidates;
identifying a set of relevant APIs from the plurality of API candidates using vector database similarity search results;
executing the query on the set of relevant APIs by a large language model (LLM) API orchestrator;
filtering API responses received from each API in the set of relevant APIs, by the LLM API orchestrator, wherein extraneous information is filtered from the API responses; and
generating a query response using unfiltered data from each response in the API responses received from each API in the set of relevant APIs, wherein the query response is presented to the user via the UI device.

16. The one or more computer storage devices of claim 15, wherein the operations further comprise:
executing the query on multiple APIs in the set of relevant APIs simultaneously in parallel to respond to a single user query.

17. The one or more computer storage devices of claim 15, wherein the operations further comprise:
executing the query on multiple APIs in the set of relevant APIs simultaneously in sequence to respond to a single user query.

18. The one or more computer storage devices of claim 15, wherein the operations further comprise:
identifying a missing parameter for executing the query on a given API in the set of relevant APIs;
prompting the user to input the missing parameter via the UI device; and
performing dynamic slot filling to add the missing parameter prior to executing the query on the given API.

19. The one or more computer storage devices of claim 15, wherein the operations further comprise:
performing authentication for each API in the set of relevant APIs by the LLM API orchestrator.

20. The one or more computer storage devices of claim 15, wherein the operations further comprise:
receiving a first query and a second query via the UI device;
performing a first vector database similarity search to identify a first API relevant to the first query and a second vector database similarity search to identify a second API relevant to the second query;
executing the first API and the second API simultaneously in parallel; and
generating a first query response using a first response data received from the first API and a second query response data using a second response received from the second API.
